(19) United States
(12) Patent Application Publication
(10) Pub. No.: US 2024/0403998 A1
(43) Pub. Date: Dec. 5, 2024

(54) VIRTUAL CAMERA RENDERING FOR USER FRAMING ADJUSTMENTS

(71) Applicant: Apple Inc., Cupertino, CA (US)

(72) Inventors: Shuang Gao, San Jose, CA (US); Zixuan Li, Cupertino, CA (US); Janardhan Kumar Amburi, San Jose, CA (US); Tanvi M. Jivtode, Mountain View, CA (US); Tim Ko, San Jose, CA (US)

(73) Assignee: Apple Inc., Cupertino, CA (US)

(21) Appl. No.: 18/679,154

(22) Filed: May 30, 2024

Related U.S. Application Data
(60) Provisional application No. 63/470,810, filed on Jun. 2, 2023.

(51) Int. Cl. G06T 3/20; G06T 3/40; G06T 5/80

(52) U.S. Cl. CPC G06T 3/20; G06T 3/40; G06T 5/80; G06T 2200/24; G06T 2207/10016

(57) ABSTRACT

In one embodiment, a method may include receiving, by an operating system running on a computing device, first image data from a physical camera of the computing device, the operating system being associated with one or more applications. The method may include identifying, by the operating system, a virtual camera control to be performed on the first image data, the virtual camera control configured to represent a physical camera control of the physical camera. The method may include generating, by the operating system, manipulated image data based at least in part on the first image data and the identified virtual camera control. The method may include providing, by the operating system, at least a portion of the manipulated image data to a particular application of the one or more applications.

### CROSS-REFERENCES TO OTHER APPLICATIONS

This application claims priority to U.S. Provisional Application No. 63/470,810, for “VIRTUAL CAMERA RENDERING FOR USER FRAMING ADJUSTMENTS” filed on Jun. 2, 2023, which is herein incorporated by reference in its entirety for all purposes.

### BACKGROUND

This disclosure relates generally to image processing and display. More specifically, this disclosure relaters to virtualizing a physical camera.

### BRIEF SUMMARY

In one embodiment, a method may include receiving, by an operating system running on a computing device, first image data from a physical camera of the computing device, the operating system being associated with one or more applications. The method may include identifying, by the operating system, a virtual camera control to be performed on the first image data, the virtual camera control configured to represent a physical camera control of the physical camera. The method may include generating, by the operating system, manipulated image data based at least in part on the first image data and the identified virtual camera control. The method may include providing, by the operating system, at least a portion of the manipulated image data to a particular application of the one or more applications.

In some embodiments, the method may include storing, by the operating system of the computing device, the virtual camera control as one or more settings associated with the computing device. The method may also include receiving, by the operating system, second image data. The method may also include applying, by the operating system, settings corresponding to the identified virtual camera control to the second image. The method may also include generating, by the operating system, second manipulated image data based at least in part on the second image data and the identified virtual camera control. The method may also include providing, by the operating system, at least a portion of the second manipulated image data to the particular application.

In some embodiments, identifying the virtual camera control may include detecting, by the operating system, an object within the image data and determining, by the computing device, whether to center the object within an output frame of the image data. In accordance with a determination to center the object within the output frame, identifying the virtual camera control may also include centering, by the operating system, the object within a threshold amount of a center of the output frame, the manipulated image data further transformed.

In some embodiments, a corrective operation may include at least one of a motion control or a distortion correction. Performing the virtual camera control may include receiving, by the operating system, a user input corresponding to the virtual camera control and performing, by the operating system, the virtual camera control on the first image data based at least in part on the user input. Performing the virtual camera control may include automatically centering an object in a field of view of the physical camera.

In some embodiments, the particular application is executed on the computing device. In other embodiments, the particular application is executed on a second computing device, and providing the manipulated image data to the particular application may include transmitting the manipulated image data to the second computing device.

In some embodiments, the method may include storing, by the operating system of the computing device, the virtual camera control as one or more settings associated with the computing device. The method may include receiving, by the operating system, second image data. The method may include applying, by the operating system, settings corresponding to the identified virtual camera control to the second image. The method may include generating, by the operating system, second manipulated image data based at least in part on the second image data and the identified virtual camera control. The method may include providing, by the operating system, at least a portion of the second manipulated image data to the particular application.

In some embodiments, the first image data may include video data associated with a live video stream captured by the physical camera. The virtual camera control may include an image correction operation. The first image data may include a full sensor readout characterized by a first resolution, and where generating the manipulated data further may include receiving, by a virtual camera of the operating system, a signal corresponding to the virtual camera control from the operating system. The method may include performing, by the virtual camera of the operating system, the virtual camera control by altering at least a portion of the full sensor readout. The method may include generating, by the virtual camera of the operating system, the manipulated image data from the altered portion of the full sensor readout, the manipulated image data characterized by a second resolution, less than the first resolution.

In some embodiments, identifying the virtual camera control may include detecting, by the operating system, an object within the image data. The method may include determining, by the computing device, whether to center the object within an output frame of the image data, The method may include, in accordance with a determination to center the object within the output frame, centering, by the operating system, the object within a threshold amount of a center of the output frame. The manipulated image data may be further transformed. A corrective operation may include at least one of a motion control or a distortion correction. Performing the virtual camera control may include receiving, by the operating system, a user input corresponding to the virtual camera control. The method may include performing, by the operating system, the virtual camera control on the first image data based at least in part on the user input. Performing the virtual camera control may include automatically centering an object in a field of view of the physical camera. The virtual camera control may include an image correction operation.

A system may include one or more processors and a computer-readable memory including instructions, that, when executed by the one or more processors, cause the system to perform operations. According to the operations, the system may receive, by an operating system running on a computing device, first image data from a physical camera of the computing device, the operating system being associated with one or more applications. The system may identify, by the operating system, a virtual camera control to be performed on the first image data, the virtual camera control configured to represent a physical camera control of the physical camera. The system may generate, by the operating system, manipulated image data based at least in part on the first image data and the identified virtual camera control. The system may provide, by the operating system, at least a portion of the manipulated image data to a particular application of the one or more applications.

A non-transitory computer-readable medium may include instructions that, when executed by the one or more processors, cause the one or more processors to perform operations. The operations may include receiving, by an operating system running on a computing device, first image data from a physical camera of the computing device. The operating system may be associated with one or more applications. The operations may include identifying, by the operating system, a virtual camera control to be performed on the first image data, the virtual camera control configured to represent a physical camera control of the physical camera. The operations may include generating, by the operating system, manipulated image data based at least in part on the first image data and the identified virtual camera control. The operations may include providing, by the operating system, at least a portion of the manipulated image data to a particular application of the one or more applications.

### BRIEF DESCRIPTION OF THE DRAWINGS

FIG. 1 illustrates computing system and a process for centering image data via a virtual camera module, according to certain embodiments.

FIG. 2 illustrates computing system and a process for virtually rotating image data using a virtual camera module, according to certain embodiments.

FIG. 3 illustrates a block diagram of a computing device with a virtual camera module, according to certain embodiments.

FIG. 4 illustrates a block diagram of a computing device with a virtual camera module providing image data to an application, according to certain embodiments.

FIG. 5 illustrates a block diagram of a computing device with a virtual camera module storing settings associated with one or more virtual camera controls, according to certain embodiments.

FIG. 6 illustrates a flowchart of a method for providing manipulated image data to a particular application, according to certain embodiments.

FIG. 7 illustrates an example architecture or environment configured to implement techniques relating to detecting eye health events, according to certain embodiments.

### DETAILED DESCRIPTION

Many consumer devices such as mobile phones, tablets, televisions, computer displays, and the like, include cameras built into the device. These devices are frequently used to capture and stream image data (such as video data) during video calls, videoconferences, etc. Because the cameras may be built into the device, there may be image distortion or image positioning issues based on the positioning of the device. For example, configuring a webcam for use during video calls may require adjusting a physical position of the webcam by adjusting the camera's physical position (e.g., translation) or its heading (e.g., rotation) or otherwise exerting some physical control on the webcam. Sometimes, there may be no ideal position to capture the desired image by moving the webcam, due to convenience, desk setup, etc. Thus, the images generated may off center, rotated, or focused poorly. For devices with built in cameras, the camera may not be physically moved without moving the device itself, exacerbating these issues.

Some applications that access the image data from the cameras may provide some camera controls. For example, many applications may provide a digital zoom feature, where the application zooms in on a portion of the image data. The applications may provide other image controls and image corrections. However, these controls are done at the application level, with image data reduced to a resolution necessary for display (e.g., 1080p). The cameras themselves, however, may capture data at a higher resolution, such as 10 megapixels. By using higher resolution image data, image corrections and camera controls may be applied more precisely and/or effectively. Furthermore, if this higher resolution image data is corrected and manipulated via camera controls at a system-level, every application that access the manipulated image data would receive the same, manipulated image data as if it were coming from the camera directly. By using this manipulated data, camera controls and corrections may be applied once at the system level (e.g., via an operating system (OS), OS-level application, kernel, etc.), eliminating a need to adjust the images within each application.

One way to apply camera controls and corrections on a system level may be to virtualize the physical camera. A physical camera of a computing device may capture raw image data, for example, through a lens during a video conference. The raw image data may then be processed by an image signal processor. The image signal processor may transform the raw image data into a digital format at a high resolution, such as 10 megapixels. The image signal processor may then output a full sensor readout including the raw image data to a virtual camera module. The virtual camera module may then apply virtual camera controls including image correction operations, and virtual camera controls corresponding to physical camera controls (e.g., panning, tilting, zooming, etc.) on the full sensor readout, generating manipulated image data. The virtual camera module may also reduce the resolution to a useable level such that the manipulated image data may be displayed by the computing device. The virtual camera module may then output the manipulated image data to a graphics processing unit that prepares the manipulated image data for display. One or more applications may then receive the manipulated image data from the GPU, and display, record, or further edit the manipulated image data. Because the virtual camera module performs the virtual camera controls and image correction operations on the full sensor readout and before any applications receive any image data, the virtual camera module can appear to be a physical camera, providing corrected images to any relevant application.

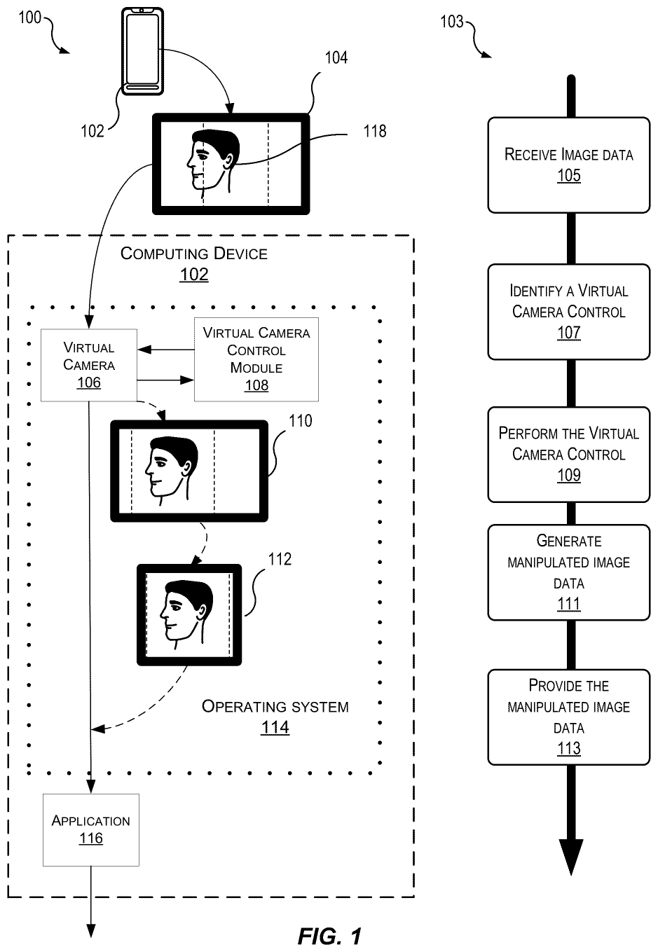

FIG. 1 illustrates computing system 100 and a process 103 for centering image data 104 via a virtual camera module 106, according to certain embodiments. The computing system 100 may include a computing device 102. The computing device 102 may be a computing device including a camera such as a mobile phone, tablet, laptop, television, computer display, wearable device, or some other such device. The computing device 102 may include one or more processors (e.g., a graphics processing unit (GPU), and image signal processor (ISP), etc.), computer-readable memories, I/O modules, and/or other such components.

An operating system 114 running on the computing device 102 may include a virtual camera module 106 and virtual camera control module 108. The virtual camera module 106 may include a system-level component of the operating system 114, operating one the image data 104 before the image data 104 is processed by a GPU. A system-level access component may be invisible to application-level programs running on the computing device 102. In other words, to an application-level program, data provided by the system-level component may appear to be no different than other data provided by operating system 114. For instance, a physical camera of the computing device 102 may provide image data to one or more applications from an operating system without a virtual camera module, via a GPU. In the present example, the virtual camera module 106 may be operate on the image data 104 to generate the manipulated image data 112 before the GPU process the image data 104. The application 116 may receive the manipulated image data from the GPU. In effect, at least from the application 116's perspective, the manipulated data provided using the virtual camera module 106 is the same as the image data from the physical camera. The virtual camera module 106 may thereby virtualize the physical camera. This virtualization extends into camera controls as well, as the virtual camera module 106 may manipulate image data to correspond with image data generated through physical camera controls.

The virtual camera control module 108 may include virtual camera controls representing physical camera controls. The virtual camera control module 108 may provide inputs corresponding to a virtual camera control to the virtual camera module 106 such that the virtual camera module 106 manipulates image data. By modeling the virtual camera's position and rotation, a variety of camera movements in cinematography can be emulated. For instance, a virtual camera control may represent the physical control of panning. Panning generally involves rotating a physical camera in order to change a perspective of the physical camera. The virtual camera control module 108 may therefore provide instructions to the virtual camera module 106 causing an image to be generated corresponding to rotating the physical camera (and thus displaying a new perspective).

The virtual camera control module 108 may also include image correction controls. The image correction controls may include controls for motion correction, distortion correction, focal length correction, light correction, and any other such image correction. The image correction controls may represent physical controls of the physical camera. For example, an image may appear washed out due to poor lighting. The virtual camera control module 108 may include controls to adjust the image data associated with the image to correct a light level of the image. In some embodiments, the light level may be corrected on a per-pixel basis. A physical control for lighting may include an aperture adjustment of a lens of a physical camera, applying a filter, or other such corrections. Thus, the virtual camera control module 108 may include virtual image correction controls that represent physical image correction controls.

In another example, the virtual camera control module 108 may include an auto-leveling function. The computing device 102 may include one or more gyroscopes and functionality to detect motion and/or an orientation with respect to gravity. The virtual camera control module 108 may receive data from the one or more gyroscopes corresponding to motion and/or the orientation of the computing device 102. The virtual camera control module 108 may then provide apply one or more virtual camera controls to the virtual camera module 106 such that effects on the image data related to the motion of the computing device 102 are mitigated or eliminated. The virtual camera control module 108 may also manipulate the image data such that an image appears upright regardless of the orientation of the computing device 102.

In some embodiments, the virtual camera control module 108 include a user interface displayed as part of a system-level graphical user interface (GUI). The user interface may be configured to accept user input corresponding to one or more of the virtual camera control module 108. For example, the user interface may display an image corresponding to some or all of the image data. The user interface may allow a user to center the image about a specific region or object by touching the display. The virtual camera control module 108 may then determine one or more virtual camera controls needed to center the image on the region or object. The virtual camera controls may include zoom, tilt, pan, truck, or perform any representations of physical controls of a physical camera.

In some embodiments, the virtual camera control module 108 may operate automatically. Any of all of the virtual camera control module 108 may be performed automatically in response to some detected image issue (e.g., movement, misalignment, etc.). For example, the virtual camera control module 108 may include an artificial intelligence (AI) model. The AI model may be configured to determine one or more faces and/or bodies in an image. The AI model may detect a face in the image data that is off-center in relation to the image (e.g., in the left ⅓ of the image). The AI model may then access one or more of the virtual camera control module 108 to center the image on the face (e.g., pan and zoom).

In some embodiments, all of the computing system 100 may be on a singular device. For example, the computing device 102 may include a display and a camera. The virtual camera module 106 and the virtual camera control module 108 may therefore be running as part of an operating system associated with the computing device. In some embodiments, the computing system may include one or more computing devices. For example, the virtual camera module 106 may be running on a first device and the virtual camera control module 108 may be running on a second device. The first device may be a smartphone being used as a camera for a videoconference. The image data captured by the first device may be displayed on desktop computer. The virtual camera module 106 may be running on the smartphone, while the virtual camera control module 108 may be running on the desktop. The virtual camera module 106 and virtual camera control module 108 may be components of the respective operating systems of the smartphone and the desktop. Thus, an input (either automatically generated or a user input) from the virtual camera control module 108 running on the desktop may cause the virtual camera module 106 on the smartphone to manipulate the image data. The virtual camera module 106 may then provide the operating system of the desktop with the manipulated image data. In yet another embodiment, the operating system of the desktop may provide the manipulated data to an application 116, running on a third device such as a television.

At step 105 of the process 103, the computing device 102 may receive image data 104 from a physical camera included in the computing device 102. The image data 104 may be a full sensor readout corresponding to all the image data detected by the physical camera of the computing device 102. The image data 104 may represent a full FOV of the physical camera. The image data 104 is shown with two lines marking a center area of the image data 104. It should be understood that these lines may or may not be present in actual embodiments of the disclosed techniques and are merely shown for explanatory purposes.

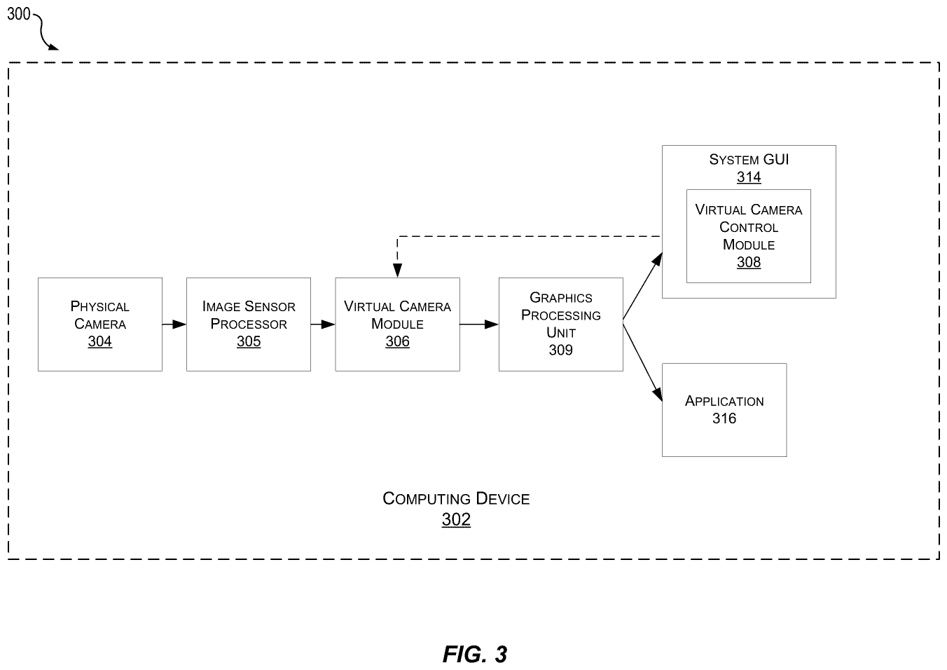

In the example shown in FIG. 1, the image data 104 may include a face 118. The face 118 may be off center, as shown in FIG. 1 by being outside the center area. Image data 104 may be received by an ISP, as discussed in FIG. 3. The ISP may then provide the image data 104 to the virtual camera module 106 of the operating system 114, running on the computing device 102. The virtual camera module 106 may be configured to manipulate the image data 104 to generate manipulated image data. The virtual camera module 106 may provide the image data 104 to the virtual camera control module 108 and/or a GUI of the operating system 114 via a GPU. In some embodiments, an image corresponding to the image data 104 may then be displayed on the computing device 102 via the GUI. Additionally or alternatively, the virtual camera control module 108 may detect that the face 118 is off center using the AI model.

At step 107 of the process 103, the virtual camera control module 108 may identify a virtual camera control to manipulate the image data 104. The virtual camera control may represent a physical control of the physical camera, such as trucking the physical camera. The virtual camera control may be identified in response to a user input via the GUI. Additionally or alternatively, the virtual camera control may be identified as part of an automatic process. In the example shown in FIG. 1, the face 118 may be off center (e.g., to the left-of-center). To center the face 118, a physical control may include trucking the physical camera and/or the computing device 102 to the left such that the face 118 is in the center area trucking. As trucking left may change the focal point of the physical camera, refocusing and/or zooming may be necessary to properly display the face 118. The virtual camera control may therefore correspond to trucking left and zooming and/or refocusing, manipulating the image data 104 as opposed to moving the physical camera.

At step 109 in the process 103, the virtual camera module 106 may perform the virtual camera control. In the example shown in FIG. 1, the virtual camera module 106 may perform the virtual camera control the image data 104 to center the face 118. First, the virtual camera module 106 may determine a center area about the face 118, as shown in intermediate image data 110. The center area may correspond to a display size and/or resolution, or be determined through a user selection, a zoom level, a focus setting, or any other suitable means. The virtual camera module 106 may then determine a portion of the image data 104, no longer be in the FOV when the face 118 is centered. For example, in intermediate image data 110, the right side of the intermediate image data 110 may not be displayed when the face 118 is centered. Thus, some of the image data 104 may not be included in any image data and/or corresponding images provided by the virtual camera module 106.

At step 111 of the process 103, the virtual camera module 106 may generate manipulated image data 112, based at least in part on the image data 104 and/or the virtual camera control. The manipulated image data 112 may correspond to a virtualized movement of the physical camera. In the example in FIG. 1, the virtualized movement may correspond to trucking the physical camera to the left. The entire image corresponding to the manipulated image data 112 may have a same perspective (e.g., not rotated) as the image data 104, but be shifted such that the face 118 is centered and some portion of the image data 104 is no longer displayed.

At step 113 of the process 103, the virtual camera module 106 may provide the manipulated image data to one or more applications such as the application 116. The application 116 may be a video conferencing application, filmmaking application or other video-or image-based application. Thus, the application 116 may display and/or edit the manipulated image data 112 or an image associated therewith. Because the virtual camera module 106 may be included in the operating system 114, the application 116 may not be able to determine that the manipulated image data 112 has been modified by the virtual camera module 106. In other words, the application 116 may see the manipulated image data 112 as a raw image based on the image data 104.

The application 116 may be associated with the operating system 114. For example, the application 116 may be native to the operating system 114 and run on the computing device. In some embodiments, the application 116 may be running on a second device via a second operating system. The operating system 114 and the second operating system may be different versions of the same operating system. For example, the operating system 114 may be configured to run on a mobile device designed by a manufacturer and the second operating system may be configured to run on a laptop also designed by the manufacturer. Both the operating systems may therefore be compatible. The applications running on the second operating system may therefore also be associated with the operating system 114.

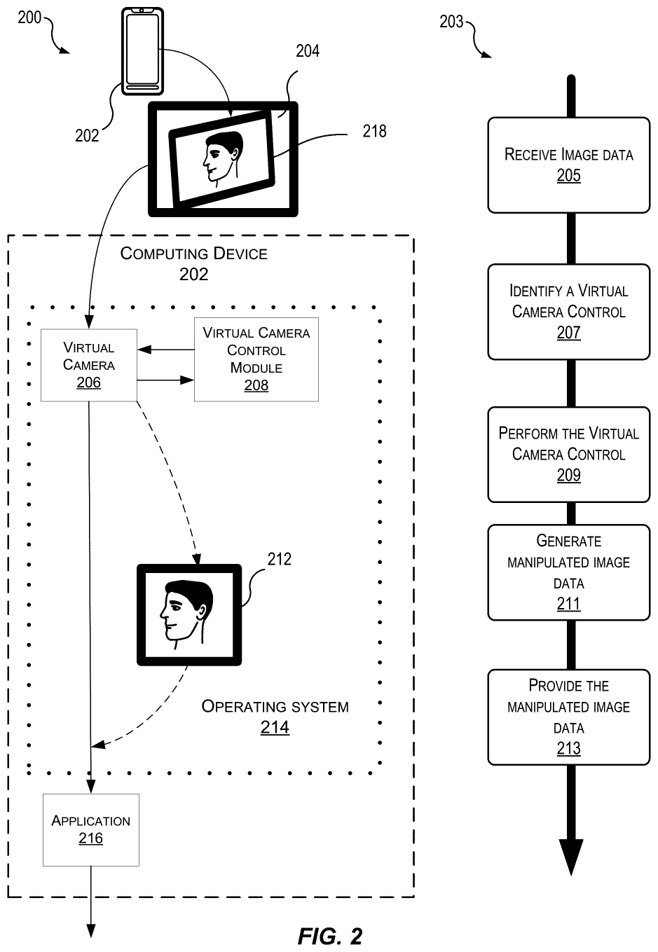

FIG. 2 illustrates computing system 200 and a process 203 for virtually rotating image data 204 using a virtual camera module 206, according to certain embodiments. The computing system 200 may be the computing system 100 described in FIG. 1. Therefore, the computing system 200 may include all or some of the components described in FIG. 1. For an explanation of individual components in FIG. 2, please see the corresponding component in FIG. 1.

At step 205 of the process 203 the computing device 202 may receive image data 204 from a physical camera included in the computing device 202. The image data 204 may be a full sensor readout corresponding to all the image data detected by the physical camera of the computing device 202.

In the example shown in FIG. 2, the image data 204 may include a face 218. The face 218 may be rotated, away from a plane of the camera. The image data 204 may therefore indicate that the physical camera of the computing device 202 is rotated with respect to the face 218. The image data 204 may be received by an ISP, as described in FIG. 3. The ISP may then provide the image data 204, including calibration data, to the virtual camera module 206 of the operating system 214, running on the computing device 202. The virtual camera module 206 may be configured to manipulate the image data 204 to generate manipulated image data 212. The virtual camera module 206 may also provide the image data 204 to the virtual camera control module 208 and/or a GUI of the operating system 214 via a GPU. In some embodiments, an image corresponding to the image data 204 may be displayed on the computing device 202 via the GUI, allowing a user to preview the image.

At step 207 of the process 203 the virtual camera control module 208 may identify a virtual camera control to manipulate the image data 204. The virtual camera control may represent a physical control of the physical camera, such as panning the physical camera. The virtual camera control may be identified in response to a user input via the GUI. Additionally or alternatively, the virtual camera control may be identified as part of an automatic process. In the example shown in FIG. 2, the face 218 may be rotated, indicating that the physical camera is not aligned with the face 218. A physical control of a physical camera may be to pan the physical camera and/or the computing device 202 such that the physical camera appears to be aligned with the face 218. Panning a physical camera may alter the focal point of the image, so refocusing and/or zooming may be necessary to properly display the face 218. The virtual camera control module 208 may identify one or more virtual camera controls that correspond to panning the image data 204 and/or performing any other virtual camera controls identified by the virtual camera control module 208.

At step 209 in the process 203, the virtual camera module 206 may perform the virtual camera control. In the example shown in FIG. 2, the virtual camera module 206 may perform the virtual camera control the image data 204 to virtually pan the virtual camera module 206 such that the physical camera appears to be aligned with the face 218. The virtual camera module 206 may also perform one or more image corrections to the image data such as distortion correction, focal corrections, and/or other image corrections such that the image associated with the manipulated image data 212 is displayed correctly.

At step 211 of the process 203, the virtual camera module 206 may generate manipulated image data 212, based at least in part on the image data 204 and/or the virtual camera control. The manipulated image data 212 may correspond to a virtualized movement of the physical camera. In the example in FIG. 2, the virtualized panning may correspond to panning the physical camera such that the physical camera appears aligned with the face 218. The image corresponding to the manipulated image data 212 may have different perspective as the image data 204.

At step 213 of the process 203, the virtual camera module 206 may provide the manipulated image data to one or more applications such as the application 216. The application 216 may be a video conferencing application, filmmaking application or other video-or image-based application. Thus, the application 216 may display and/or edit the manipulated data 212 or an image associated therewith. Because the virtual camera module 206 may be included in the operating system 224, the application 226 may not be able to determine that the manipulated image data 222 has been modified by the virtual camera module 206. In other words, the application 226 may see the manipulated image data 222 as a raw image based on the image data 204.

The application 226 may be associated with the operating system 224. For example, the application 226 may be native to the operating system 224 and run on the computing device. In some embodiments, the application 226 may be running on a second device via a second operating system. The operating system 224 and the second operating system may be different versions of the same operating system. For example, the operating system 224 may be configured to run on a mobile device designed by a manufacturer and the second operating system may be configured to run on a laptop also designed by the manufacturer. Both the operating systems may therefore be compatible. The applications running on the second operating system may therefore also be associated with the operating system 224.

FIG. 3 illustrates a block diagram 300 of a computing device 302 with a virtual camera module 306, according to certain embodiments. The computing device 302 may be similar to the computing device 102 in FIG. 1, and therefore have similar components and capabilities. Additionally, some components described in relation to FIG. 3 may be present in the computing devices 102 and 202, in FIGS. 1 and 2, respectively.

The computing device 302 may include a physical camera, 304, an image sensor processor (ISP) 305, a virtual camera module 306 and associated virtual camera control module 308, a graphics processing unit (GPU) 309, a system graphical user interface (GUI) 314, and one or more applications such as the application 316. The computing device 302 may be a mobile phone, a tablet, a laptop or other computer, a computer display, television, or any other such device.

The physical camera 304 may include one or more lenses and sensors to detect images and/or lights. The physical camera 304 maybe integrated in the computing device 302 or may be connected via USB or other such standard for connecting peripheral devices to computing devices and allowing for data transfer. Although only one physical camera 304, the computing device 302 may have any number of physical cameras. The physical camera 304 may be configured to collect raw image data such as video data. The raw image data may represent objects within a FOV of the physical camera 304, as determined by the physical characteristics of the physical camera 304 (e.g., the dimensions of a lens) and/or the placement of the physical camera 304. The raw image data may correspond to visible light, infrared, or other wavelengths of light.

The physical camera 304 may transmit the image data to the ISP 305. The ISP 305 may include a system on a chip (SoC) or other suitable processor structure and be configured to process signals received from the physical camera 304. The ISP 305 may process the raw image data by performing functions such as Bayer transformations, demosaicing, noise reduction, image sharpening, and other image processing functions. The ISP 305 may thereby generate a full sensor readout that includes all of the image data collected by the physical camera 304. The ISP may also generate calibration data associated with the physical camera 304. Due in part to the processing, the full sensor readout may be in a more usable format than the raw image data. Also, because the full sensor readout may include all of the image data collected by the physical camera 304, the full sensor readout may be used by one or more of the modules described herein to perform various detection and correction functions.

For example, the full sensor readout may be accessed by the virtual camera model 306 and/or the virtual camera control module 308 to detect motion of the computing device 302. For example, the images displayed based on the raw image data may appear to shift and change in accordance with movement of the computing device 302 (e.g., a smartphone being help by hand). While some motion correction may be performed based of the images, the full sensor readout may include more detailed and precise information associated with the movement of the computing device 302. This information may be correlated with other data from the computing device 302, such as data from one or more gyroscopes. Thus, by using the data from the full sensor readout and the other data, improved motion correction may be achieved.

The ISP 305 may then transmit the full sensor readout to the virtual camera module 306. Because the virtual camera module 306 may receive the full sensor readout, the virtual camera module 306 may have access to substantially all of the raw image data collected by the physical camera 304, albeit in a processed format (which may make manipulation of the image data easier). The virtual camera module 306 may use some or all of the full sensor readout and the calibration data to model the physical camera 304. The virtual camera module 306 may then generate a geometrically correct representation of images captured by the virtual camera which can be processed by the GPU 309 to produce the virtual camera view, output as image data (e.g., the image data 104 in FIG. 1).

The virtual camera module 306 may then output the image data to the GPU 309. The GPU 309 may be a dedicated processing unit or an integrated processing unit. The GPU may create images (or video) based on the image data received from the virtual camera module 306. Because the virtual camera module 306 may manipulate the full sensor readout before outputting the image data to the rest of the computing device 202, the virtual camera module 306 has “virtualized” the physical camera 304. In other words, the full sensor readout may allow the virtual camera module 306 to manipulate the raw sensor data via virtual camera controls that correspond to physical camera controls.

The GPU 309 may reduce a resolution of the full sensor readout to a resolution suitable for display on the computing device 302 or other computing device. As such, the images output by the GPU 309 may include less image data than a corresponding portion of the full sensor readout. The GPU 309 may then output the images to the system GUI 314 and/or the application 316. The application 316 may receive the images and output the images for display, record the images, or edit the images. Because the virtual camera module 306 is behind (in terms of data flow) the GPU 309, the virtual camera module 306 may be imperceptible to the application 316. In other words,

The system GUI 314 may also cause some portion of the images received from the GPU 309 to be displayed. For instance, a Control Panel may include the virtual camera control module 308. The virtual camera control module 308 may include an interface for interacting and manipulating the image data. The interface may include some or all of a video stream associated with the raw image data collected by the physical camera 304. The interface may accept user inputs corresponding to one or more virtual camera controls. User inputs may include touchscreen inputs, slider bars, radio buttons, and other suitable inputs.

For example, the interface may accept input corresponding to a user tapping an image of their face displayed as part of the video stream. In response to tapping the face in the video stream, the virtual camera control module 308 may transmit a signal to the virtual camera module 306 via the system GUI 314. The signal may cause the virtual camera module 306 to virtually center the video stream on the face, thus creating manipulated image data similar to the manipulated image data 112 in FIG. 1.

The computing device 302 may include multiple applications that receive image data and/or images from the GPU 309. If the raw image data from the physical camera 304 is off center, moving, or has other issues, image correction functions and/or virtual camera controls may need to be configured within each application. By virtualizing the physical camera 304 using the virtual camera module 306, each application may receive image data and/or images that have already been manipulated such that no other camera control and/or image correct are needed.

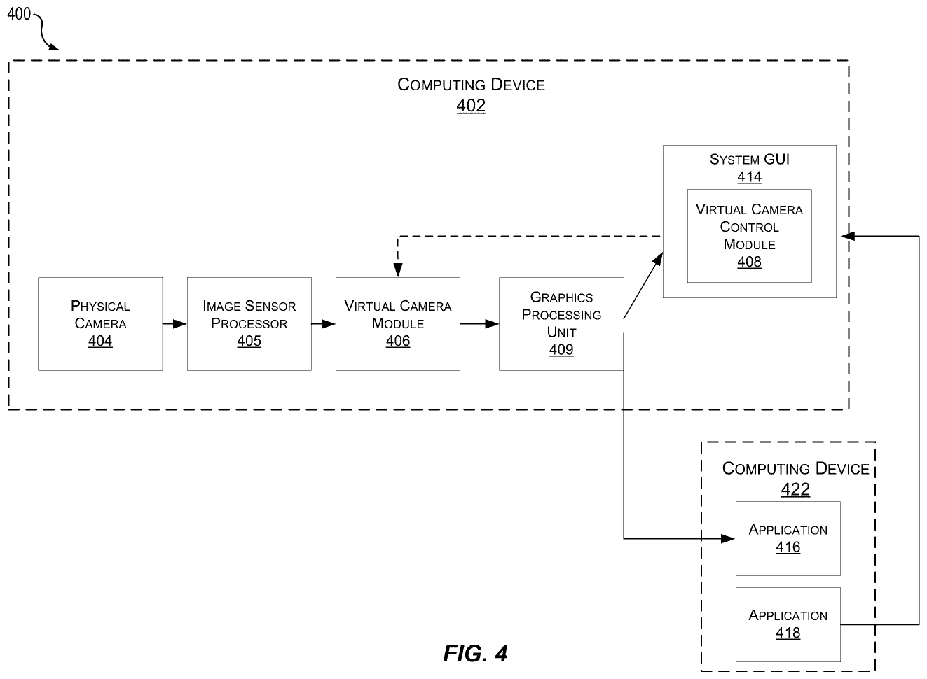

FIG. 4 illustrates a block diagram 400 of a computing device 402 with a virtual camera module 406 providing image data to an application 416, according to certain embodiments. The computing device 402 may be similar to the computing device 302 in FIG. 3. As such, the computing device 402 may include some or all of the functionality of the computing device 302. The computing device 402 may include a physical camera 403, an ISP 405, a virtual camera module 406 and a virtual camera control module 408, a graphics processing unit 409, and a system GUI 414. The computing device 402 may be configured to transmit signal data to an application 416 running on a second computing device 422.

In an embodiment, the computing device 402 may be a smartphone. The computing device 422 may be a television, tablet, computer or some other user device. The application 416 may be associated with an operating system running on the computing device 402. For example, the application 416 may be configured to receive and display images and/or image data from the computing device 402 via the operating system. Continuing the example from FIG. 3, the images and/or image data received by the application 416, may be part of a video stream, such as a videoconference. The virtual camera module 406 may have virtually centered the images and/or image data on the face in the video stream. Therefore, when the application 416 received the images and/or image data, image correction and/or virtual camera control may be unnecessary.

In some embodiments, the computing device 422 may include another application 418. The application 418 may be configured to communicate with the virtual camera control module 408, running on the computing device 402. The application 418 may transmit a signal to the computing device 402 identifying one or more virtual camera controls. The signal may be received by the virtual camera control module 408 and/or the virtual camera module 406. The virtual camera module 406 may then manipulate the full sensor readout to create manipulated image data. Thus, the user may be able to apply virtual camera controls to image data from the computing device 422.

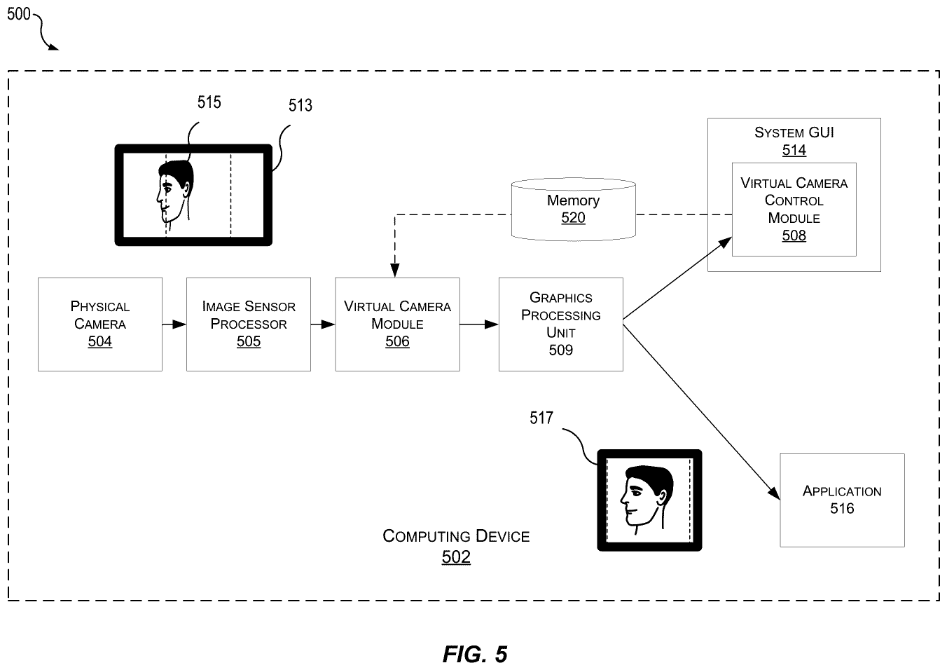

FIG. 5 illustrates a block diagram 500 of a computing device 502 with a virtual camera module 506 storing settings associated with one or more virtual camera controls, according to certain embodiments. The computing device 502 may be similar to the computing device 302 in FIG. 3. As such, the computing device 502 may include some or all of the functionality of the computing device 302. The computing device 502 may include a physical camera 504, an ISP 505, a virtual camera module 506 and a virtual camera control module 508, a graphics processing unit (GPU) 509, a system GUI 514, an application 516, and a memory 520.

In an embodiment, the computing device 502 may be a computer display with the physical camera 504 integrated in a body of the computer display. Therefore, the physical camera 504 may not be easily moveable to adjust as associated FOV without moving the entire computing device 502. At a first time, the physical camera 504 may capture raw image data 513. The raw image data 513 may include a face 515. The face 515 may be off center, similar to the face 118 in FIG. 1. Furthermore, the face 515 may appear rotated, indicating that the physical camera 504 is not pointed at aligned with the face 515. The raw image data 513 may then be processed by the ISP 505 to generate a full sensor readout. The full sensor readout may include data corresponding to most or all of the raw image data captured by the physical camera 504. In other words, the full sensor readout may include image data at a maximum resolution level.

The ISP 505 may then transmit the full sensor readout to the virtual camera module 506. The virtual camera module 506 may perform calibrate the full sensor readout such that correspond to each pixel of the full sensor readout corresponds to a region of the image captured by the physical camera, generating image data. The image data is then transmitted to the GPU 509 and processed into frames for display by the application 416 and/or the system GUI 514.

The virtual camera control module 508 may include an interface within the system GUI 514. The interface may display a portion of the image data as a preview for the user. The interface may also include one or more inputs associated with virtual camera controls. For example, the user may hold a finger on the face 515 in the video stream generated from the raw image data 513. The virtual camera control module 508 may determine that holding the finger on the face 515 indicates an input calling for a centering control be performed on the face 515. The virtual camera control module 508 may apply an AI model such as the one described in FIG. 1, where the output of the model is used to determine the face 515 in subsequent frames.

In response to the input, the virtual camera control module 508 may send a signal to the virtual camera 506 to virtually center the manipulated image data 517 on the face 515. The virtual camera module 506 may then perform one or more virtual camera controls that correspond to physical camera controls (e.g., trucking, zoom, image correction) to center the manipulated image data 517 on the face 515.

The virtual camera control module 508 may also receive an input indicating that virtual camera be virtually rotated (or panned) to correct the rotation of the face 515. In response to the input, the virtual camera module 506 may manipulate the full sensor readout such that the manipulated image data 517 appears that the physical camera is aligned with the face 515. The computing device 502 may then store the one or more virtual camera controls in the memory 520 as settings corresponding to the virtual camera module 506.

At a second time, the physical camera 504 may capture second raw image data. The computing device 502 may then access the settings stored in the memory 520. After the second raw image data is processed by the ISP 505, the virtual camera module 506 may apply the settings to a full sensor readout corresponding to the second raw image data. Therefore, when the image data is displayed by the application 516 and/or the system GUI 514 via the interface of the virtual camera control module 508, the image data may resemble the manipulated image data 517.

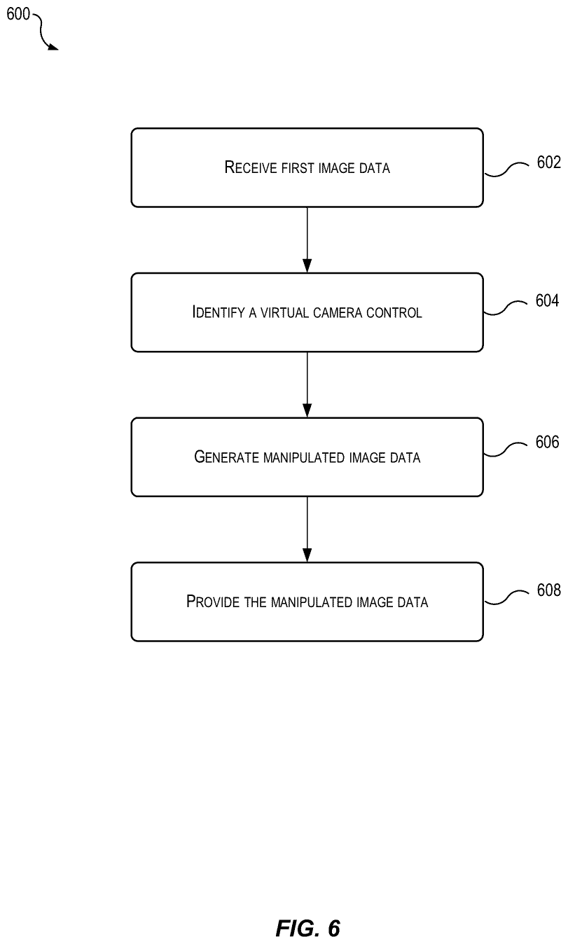

FIG. 6 illustrates a flowchart of a method 600 for providing manipulated image data to a particular application, according to certain embodiments. The method 600 may be performed by any of the systems and devices described above, such as the computing system 100 in FIG. 1, and/or the computing devices 402 and 422 in FIG. 4. Thus, in some embodiments, some steps of the method 600 may be performed by different devices working in parallel or sequentially.

At step 602, the method 600 may include receiving, by an operating system running on a computing device, first image data. The first image data may be received from and/or associated with a physical camera. In some embodiments, the physical camera may be included in the computing device. In other embodiments, the physical camera may be a peripheral device. The first image data may include a full sensor readout. The full sensor readout may be generated by an ISP included in the computing device, such as the ISP 305 in FIG. 3. The full sensor readout may be received by a virtual camera module, such as the virtual camera module 306. The first image data may include video data associated with a live video stream of the physical camera, as is described in FIG. 4. The operating system may also be associated with one or more applications. The applications may be running on the computing device or may be running on a different computing device. The one or more application may generally receive image data (or video data) from the operating system and display, edit, or record the image data.

At step 604, the method 600 may include identifying, by the operating system, a virtual camera control to be performed on the first image data. The virtual camera control may be configured to represent a physical camera control of the physical camera. For example, a physical camera may be tilted, panned, trucked, zoomed, or have any number of physical adjustments made that alter a FOV of the physical camera. The virtual camera control may include instructions that cause the virtual camera module to manipulate the full sensor readout such that it appears that a physical control has been applied to the physical camera. The virtual camera control may also include motion control, distortion correction, visual effects, light control, or any other image correction operation.

In some embodiments, one or more of the virtual camera controls may be identified based on other sensor data received by the operating system from one or more sensors included in the computing device. For example, the operating system may receive motion data from one or more gyroscopes of the computing device. The virtual camera control may then include a motion control operation, based at least in part on the motion data (e.g., an auto-leveling control).

In some embodiments, the virtual camera control may be identified automatically by the computing device. In some embodiments, the virtual camera control may be identified at least in part via a virtual camera control module such as the virtual camera control module 308 in FIG. 3. The virtual camera control module may include an interface in a system GUI of the operating system. The interface may accept one or more user inputs and perform an associated virtual camera control. The user inputs may correspond to a centering control. The centering control may cause the virtual camera model to center an image as indicated by the user input (e.g., centering the image on a figure in the image). In some embodiments, the centering control may utilize an AI model to automatically center the image on the figure in the image.

At step 606, the method 600 may include generating, by the operating system, manipulated image data based at least in part on the first image data and the identified virtual camera control. The manipulated image data may be generated by the virtual camera module. The manipulated image data may include an altered portion of the full sensor readout. The altered portion of the manipulated image data may represent the first image data, altered due to a physical camera control (e.g., panning, trucking, tilting, etc.). The manipulated image data may also be characterized by a lower resolution that a resolution of the full sensor readout. For example, the physical camera may include a 10 megapixel resolution. The full sensor readout may then include image data with a 10 megapixel resolution. The manipulated image data may be reduced to some other resolution for display on the computing device (e.g., 1080p).

At step 608, the method 600 may include providing, by the operating system, at least a portion of the manipulated image data to a particular application of the one or more applications associated with the operating system. The operating system may provide the manipulated image data via a GPU. The particular application may be unaware that the manipulated image data has been manipulated. In systems with multiple applications generating images from the manipulated image data, each of multiple applications may generate images with the virtual camera controls applied. There may be no need to further adjust the manipulated image data by applying further image correction operations and/or virtual camera controls.

In some embodiments, the method 600, identifying the virtual camera control may further include detecting an object within the first image data and/or the manipulated image data. The object may be detected automatically, in some cases via an AI model, and/or be detected in response to a user input. The operating system may then determine whether to center the object within an output frame of the first image data and/or the manipulated image data. The determination may be made automatically, in some cases using AI, and/or in response to a user input. In accordance with a determination to center the object within the output frame, the operating system may center the object within a threshold amount of a center of the output frame (e.g., 10 pixels, 100 pixels, etc.). The centering may be performed by the virtual camera module, wherein the virtual camera module further alters at least a portion of the full sensor readout. This, the manipulated image data is further transformed.

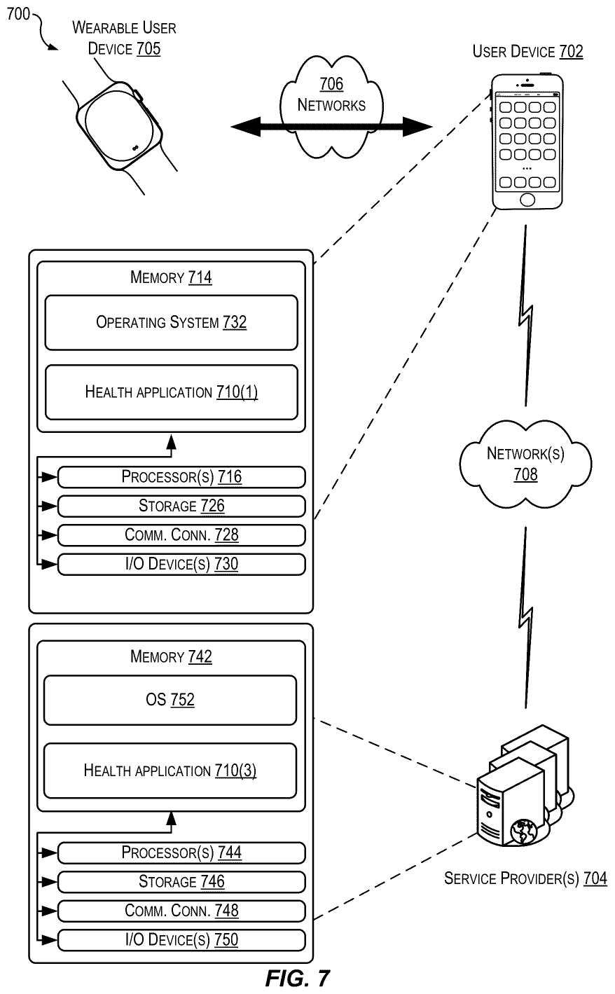

FIG. 7 illustrates an example architecture or environment 700 configured to implement techniques relating to detecting eye health events, according certain embodiments. In some examples, the example architecture 700 may further be configured to enable a user device 702 (e.g., the computing device 102), the service provider computers 704 (e.g., the service provider 704), and a wearable electronic device 705 (e.g., an example accessory deice) to share information. In some examples, the devices may be connected via one or more networks 708 and/or 706 (e.g., via Bluetooth, WiFi, the Internet, or the like). In the architecture 700, one or more users may utilize the user device 702 to manage, control, or otherwise utilize the wearable electronic device 705, via the one or more networks 706. Additionally, in some examples, the wearable electronic device 705, the service provider computers 704, and the user device 702 may be configured or otherwise built as a single device. For example, the wearable electronic device 705 and/or the user device 702 may be configured to implement the examples described herein as a single computing unit, exercising the examples described above and below without the need for the other devices described.

In some examples, the networks 706, 708 may include any one or a combination of many different types of networks, such as cable networks, the Internet, wireless networks, cellular networks, satellite networks, other private and/or public networks, or any combination thereof. While the illustrated example represents the user device 702 accessing the service provider computers 704 via the networks 708, the described techniques may equally apply in instances where the user device 702 interacts with the service provider computers 704 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

The user device 702 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 702 may be in communication with the service provider computers 704 via the networks 708, 706, or via other network connections.

In one illustrative configuration, the user device 702 may include at least one memory 714 and one or more processing units (or processor(s)) 716. The processor(s) 716 may be implemented as appropriate in hardware, computer-executable instructions, firmware, or combinations thereof. Computer-executable instruction or firmware implementations of the processor(s) 716 may include computer-executable or machine-executable instructions written in any suitable programming language to perform the various functions described. The user device 702 may also include geo-location devices (e.g., a global positioning system (GPS) device or the like) for providing and/or recording geographic location information associated with the user device 702.

The memory 714 may store program instructions that are loadable and executable on the processor(s) 716, as well as data generated during the execution of these programs. Depending on the configuration and type of the user device 702, the memory 714 may be volatile (such as random access memory (RAM)) and/or non-volatile (such as read-only memory (ROM), flash memory, etc.). The user device 702 may also include additional removable storage and/or non-removable storage 726 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 714 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 714 and the additional storage 726, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 714 and the additional storage 726 are both examples of non-transitory computer storage media. Additional types of computer storage media that may be present in the user device 74 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 702. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 702 may also contain communications connection(s) 728 that allow the user device 702 to communicate with a data store, another computing device or server, user terminals, and/or other devices via the networks 708, 706. The user device 702 may also include I/O device(s) 730, such as a keyboard, a mouse, a pen, a voice input device, a touch input device, a display, an operating system 732 and/or one or more application programs or services for implementing the features disclosed herein including a health application 710(1). In some examples, the health application 710(1) may be configured to implement the features described herein such as those described with reference to the flowcharts.

The service provider computers 704 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 704 may be in communication with the user device 702 and/or the wearable user device 705 via the networks 708, 706, or via other network connections.

In one illustrative configuration, the service provider computers 704 may include at least one memory 742 and one or more processing units (or processor(s)) 744. The processor(s) 744 may be implemented as appropriate in hardware, computer-executable instructions, firmware, or combinations thereof. Computer-executable instruction or firmware implementations of the processor(s) 744 may include computer-executable or machine-executable instructions written in any suitable programming language to perform the various functions described.

The memory 742 may store program instructions that are loadable and executable on the processor(s) 744, as well as data generated during the execution of these programs. Depending on the configuration and type of service provider computer 704, the memory 742 may be volatile (such as RAM) and/or non-volatile (such as ROM, flash memory, etc.). The service provider computer 704 may also include additional removable storage and/or non-removable storage 746 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 742 may include multiple different types of memory, such as SRAM, DRAM, or ROM. While the volatile memory described herein may be referred to as RAM, any volatile memory that would not maintain data stored therein once unplugged from a host and/or power would be appropriate. The memory 742 and the additional storage 746, both removable and non-removable, are both additional examples of non-transitory computer-readable storage media.

The service provider computer 704 may also contain communications connection(s) 748 that allow the service provider computer 704 to communicate with a data store, another computing device or server, user terminals and/or other devices via the networks 708, 706. The service provider computer 704 may also include I/O device(s) 750, such as a keyboard, a mouse, a pen, a voice input device, a touch input device, a display, speakers, a printer, etc. The memory 742 may include an operating system 752 and/or one or more application programs or services for implementing the features disclosed herein including the health application 710(3).

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C#or C++, or any scripting language, such as Perl, Python or TCL, as well as combinations thereof. The server(s) may also include database servers, including without limitation those commercially available from Oracle®, Microsoft® Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The present disclosure recognizes that the use of such personal information data, in the present technology, can be used to the benefit of users. For example, the personal information data can be used to provide a family member or friend a view of health data updates. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health- related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
receiving, by an operating system running on a computing device, first image data from a physical camera of the computing device, the operating system being associated with one or more applications;
identifying, by the operating system, a virtual camera control to be performed on the first image data, the virtual camera control configured to represent a physical camera control of the physical camera;
generating, by the operating system, manipulated image data based at least in part on the first image data and the identified virtual camera control; and
providing, by the operating system, at least a portion of the manipulated image data to a particular application of the one or more applications.

2. The method of claim 1, further comprising:
storing, by the operating system of the computing device, the virtual camera control as one or more settings associated with the computing device;
receiving, by the operating system, second image data;
applying, by the operating system, settings corresponding to the identified virtual camera control to the second image;
generating, by the operating system, second manipulated image data based at least in part on the second image data and the identified virtual camera control; and
providing, by the operating system, at least a portion of the second manipulated image data to the particular application.

3. The method of claim 1, wherein the first image data comprises video data associated with a live video stream captured by the physical camera.

4. The method of claim 1, wherein the virtual camera control comprises an image correction operation.

5. The method of claim 1, wherein the first image data comprises a full sensor readout characterized by a first resolution, and wherein generating the manipulated data further comprises:
receiving, by a virtual camera of the operating system, a signal corresponding to the virtual camera control from the operating system;
performing, by the virtual camera of the operating system, the virtual camera control by altering at least a portion of the full sensor readout; and
generating, by the virtual camera of the operating system, the manipulated image data from the altered portion of the full sensor readout, the manipulated image data characterized by a second resolution, less than the first resolution.

6. The method of claim 1, wherein the identifying the virtual camera control comprises:
detecting, by the operating system, an object within the image data;
determining, by the computing device, whether to center the object within an output frame of the image data; and
in accordance with a determination to center the object within the output frame, centering, by the operating system, the object within a threshold amount of a center of the output frame, and wherein the manipulated image data is further transformed.

7. The method of claim 1, wherein a corrective operation comprises at least one of a motion control or a distortion correction.

8. The method of claim 1, wherein performing the virtual camera control comprises:
receiving, by the operating system, a user input corresponding to the virtual camera control; and
performing, by the operating system, the virtual camera control on the first image data based at least in part on the user input.

9. The method of claim 1, wherein performing the virtual camera control comprises automatically centering an object in a field of view of the physical camera.

10. The method of claim 1, wherein the particular application is executed on the computing device.

11. The method of claim 1, wherein the particular application is executed on a second computing device, and wherein providing the manipulated image data to the particular application comprises transmitting the manipulated image data to the second computing device.

12. A system, comprising:
one or more processors; and
a computer-readable memory comprising instructions, that, when executed by the one or more processors, cause the system to perform operations to:
receive, by an operating system running on a computing device, first image data from a physical camera of the computing device, the operating system being associated with one or more applications;
identify, by the operating system, a virtual camera control to be performed on the first image data, the virtual camera control configured to represent a physical camera control of the physical camera;
generate, by the operating system, manipulated image data based at least in part on the first image data and the identified virtual camera control; and
provide, by the operating system, at least a portion of the manipulated image data to a particular application of the one or more applications.

13. The system of claim 12, wherein the first image data comprises video data associated with a live video stream captured by the physical camera.

14. The method of claim 1, wherein the virtual camera control comprises an image correction operation.

15. A non-transitory computer-readable medium comprising instructions that, when executed by one or more processors, cause the one or more processors to perform operations comprising:
receiving, by an operating system running on a computing device, first image data from a physical camera of the computing device, the operating system being associated with one or more applications;
identifying, by the operating system, a virtual camera control to be performed on the first image data, the virtual camera control configured to represent a physical camera control of the physical camera;
generating, by the operating system, manipulated image data based at least in part on the first image data and the identified virtual camera control; and
providing, by the operating system, at least a portion of the manipulated image data to a particular application of the one or more applications.

16. A non-transitory computer-readable medium of claim 15, the operations further comprising:
storing, by the operating system of the computing device, the virtual camera control as one or more settings associated with the computing device;
receiving, by the operating system, second image data;
applying, by the operating system, settings corresponding to the identified virtual camera control to the second image;
generating, by the operating system, second manipulated image data based at least in part on the second image data and the identified virtual camera control; and
providing, by the operating system, at least a portion of the second manipulated image data to the particular application.

17. A non-transitory computer-readable medium of claim 15, wherein the first image data comprises video data associated with a live video stream captured by the physical camera.

18. A non-transitory computer-readable medium of claim 15, wherein the virtual camera control comprises an image correction operation.

19. A non-transitory computer-readable medium of claim 15, wherein the first image data comprises a full sensor readout characterized by a first resolution, and wherein generating the manipulated data further comprises:
receiving, by a virtual camera of the operating system, a signal corresponding to the virtual camera control from the operating system;
performing, by the virtual camera of the operating system, the virtual camera control by altering at least a portion of the full sensor readout; and
generating, by the virtual camera of the operating system, the manipulated image data from the altered portion of the full sensor readout, the manipulated image data characterized by a second resolution, less than the first resolution.

20. A non-transitory computer-readable medium of claim 15, wherein the identifying the virtual camera control comprises:
detecting, by the operating system, an object within the image data;
determining, by the computing device, whether to center the object within an output frame of the image data; and
in accordance with a determination to center the object within the output frame, centering, by the operating system, the object within a threshold amount of a center of the output frame, and wherein the manipulated image data is further transformed.
